(19) United States
(12) Patent Application Publication
(10) Pub. No.: US 2025/0371400 A1
(43) Pub. Date: Dec. 4, 2025

(54) Quantum chip and method of performing quantum computation on said quantum chip

(71) Applicant: IQM Finland Oy, Espoo (FI)

(72) Inventors: Fedor Šimkovic, Munich (DE); Francisco Revson Fernandes Pereira, Munich (DE); Hsiang-Sheng Ku, Munich (DE)

(21) Appl. No.: 19/227,938

(22) Filed: Jun. 4, 2025

(30) Foreign Application Priority Data
Jun. 4, 2024 (FI) 20245718

(51) Int. Cl. G06N 10/40; G06N 10/20; G06N 10/70

(52) U.S. Cl. CPC G06N 10/40; G06N 10/20; G06N 10/70

(57) ABSTRACT

A quantum chip including a number of unit cells arranged in a two-dimensional pattern, each unit cell including at least one coupling structure and at least two qubits coupled thereto, wherein there are at least three adjacent unit cells with only a single qubit of the qubits of the at least three adjacent unit cells coupled to the at least one coupling structure of each of the three adjacent unit cells.

### CROSS-REFERENCE TO RELATED APPLICATIONS

This application claims the benefit of and priority to Finnish Patent Application No. 20245718, filed Jun. 4, 2024, the entire contents of which are incorporated by reference herein.

### BACKGROUND

The invention is related to a quantum chip comprising a plurality of unit cells arranged in a two-dimensional pattern, each unit cell comprising at least one coupling structure and at least two qubits coupled thereto, and to a method of performing quantum computation on said quantum chip.

A quantum chip described above is disclosed, e.g., in WO 2023/041833 A1 or in PCT/FI2023/050727. These quantum chips have the advantage that they provide a connectivity between the qubits which may be beyond the connectivity of quantum chips in which spatially neighboring qubits are coupled via direct qubit-qubit coupling. In general, a high connectivity of the quantum chip is desirable as it may allow for an efficient implementation of quantum computation.

In particular, WO 2023/041833 A1 discloses, for example in its FIG. 2, a quantum chip having three resonators 203a,b,c, each coupled to a plurality of qubits. There are qubits coupled to two of the resonators whereby a high connectivity is obtained. The quantum chip may thus be used for the efficient implementation of various quantum algorithms, for example, the Quantum Fourier Transform.

PCT/FI2023/050727 discloses a quantum chip wherein connectivity is provided via two layers. E.g., FIG. 1a of PCT/FI2023/050727 discloses a plurality of unit cells arranged in a two-dimensional pattern. In particular, a first unit cell comprises the two qubits 4b and 5a coupled to the resonator P1a at the plaquette 10 by tunable couplers P1b, a second unit cell comprises the two qubits 5b and 6a coupled to the resonator P1a at the plaquette 20 by tunable couplers P1b, a third unit cell comprises the two qubits 7b and 8a coupled to the resonator P1a at the plaquette 30 by tunable couplers P1b, and a fourth unit cell comprises the two qubits 8b and 9a coupled to the resonator P1a at the plaquette 40 by tunable couplers P1b. The unit cells are arranged in one layer. The qubits of each unit cell are coupled to resonators of other unit cells by tunable couplers P1a arranged in the same layer as the unit cells or by tunable couplers P2 arranged in another layer. Furthermore, the neighboring qubits of the quantum chip are also coupled by direct qubit-qubit coupling. The quantum chip disclosed in PCT/FI2023/050727 has a high connectivity between the qubits and a good quality since there are no crossings between tunable couplers and resonators in the same layer. This quantum chip is particularly well-suited for efficiently implementing fermionic simulations.

PCT/EP2023/080723 discloses a quantum chip with a plurality of resonators arranged adjacent to each other and each having a plurality of qubits coupled thereto. Long-range connectivity is enhanced by a shortcut coupling structure coupling to qubits at the ends of the resonators.

While quantum chips comprising qubits coupled to coupling structures may have a high connectivity, there is a limitation regarding the maximum number of qubits which may couple to the same coupling structure. For example, state-of-the art resonators may have about 20 qubits coupled thereto. This maximum number of qubits may thus limit the connectivity of the quantum chip.

An alternative solution for providing high-connectivity quantum chips and/or quantum chips with a connectivity between spatially distant qubits comprises the use of airbridges or the use of flip-chip technology where short- and long-range coupling structures are provided on different sides of the flip-chip or the use of additional layers beyond the flip chip technology. These solutions face the problem that a single qubit may only couple to a limited number of coupling structures. Furthermore, airbridges have the disadvantage that their use results in a reduction of the performance of the quantum chip. In addition, due to the vertical extension of airbridges, they may not be used in combination with the flip-chip technology. Quantum chips using the flip-chip technology or additional layers beyond the flip chip technology may suffer from performance losses due to the distribution of elements on the different layers of the chip.

Due to these problems in the prior art, it is therefore an object of the present invention to provide a quantum chip with an improved connectivity between the qubits without suffering from the aforementioned adverse effects and to provide a method for efficiently performing quantum computation.

### SUMMARY

This object is solved in accordance with a first aspect of the present invention by a quantum chip of the afore mentioned type, wherein there are at least three adjacent unit cells with only a single qubit of the qubits of the at least three adjacent unit cells coupled to the at least one coupling structure of each of the three adjacent unit cells.

Such a quantum chip may be realized using qubits and coupling structures which are known in the art. The quantum chip according to the present invention may have a higher connectivity than known quantum chips, in particular those with only qubit-qubit coupling between nearest neighbor qubits. In particular, the connectivity may be higher than for the quantum chip disclosed in WO 2023/041833 A1 where there is no qubit which is coupled to more than two coupling structures for each unit cell. Furthermore, in contrast to the quantum chip disclosed in PCT/FI2023/050727, where each of the four adjacent unit cells has a qubit coupled to the coupling structure of the four adjacent unit cells, there is no need for two layers and/or direct qubit-qubit coupling to obtain this high connectivity.

Due to its high connectivity, the quantum chip according to the present invention may be particularly well-suited for the execution of many interesting quantum algorithms, as their execution on the quantum chip according to the present invention may require a reduced number of SWAP or MOVE gates compared to an execution on a quantum chip of the prior art. Even further, the quantum chip according to the present invention allows to achieve the high connectivity even when only a limited number of qubits, preferably at most 20 qubits, more preferably at most 15 qubits, even more preferably at most 10 qubits, and further preferably at most six qubits are coupled to one coupling structure. Furthermore, since only a limited number of qubits is coupled to each coupling structure, a larger number of quantum gates may be implemented in parallel, in particular compared to the quantum chip disclosed in WO 2023/041833 A1.

The quantum chip according to the present invention further has the beneficial property that crossings of the coupling structures may not be required either in-plane (i.e., in the same plane), or out-of-plane (I.e., there are no in-plane crossings, but there are crossings in a plan view on the quantum chip due to coupling structures arranged in different planes.). By avoiding crossings, a deterioration of the quality of the quantum chip may be prevented.

In one example, there may be a single type of unit cell in the pattern, but the invention is not limited to this. In one example, the unit cell may comprise a single coupling structure. In other examples, the unit cell may comprise more than one coupling structure. The qubits of the unit cell may then be coupled to only one of the coupling structures, they may be coupled to more than one coupling structure or to all coupling structures of the unit cell. The qubit of a unit cell may also be coupled to the at least one coupling structure of one or more adjacent unit cells as long as for at least three adjacent unit cells there is only a single qubit of the at least three adjacent unit cells coupled to the at least one coupling structure of each of the three adjacent unit cells.

The qubits of the unit cell are coupled to the at least one coupling structure. Thereby, connectivity is provided between the qubits coupled to the at least one coupling structure. In particular, the coupling between the qubits and the at least one coupling structure may enable to selectively apply two-qubit gates between qubits coupled to the at least one coupling structure. In particular, the coupling structure is configured to enable two-qubit gates between qubits coupled thereto without affecting the states of other (spectator) qubits coupled to the same coupling structure. The unit cells are equivalent in the number of qubits coupled to the at least one coupling structure, but they may differ in terms of the relative position between the at least one coupling structure and the qubits coupled thereto in certain examples. In particular, such configurations may be beneficial to obtain space-saving quantum chips.

In one example, the unit cell may comprise only two qubits, and the two qubits are coupled to the at least one coupling structure. In this case, the qubit-to-coupling structure ratio is 2 to 1 which is optimal for parallelism, i.e., a parallel application of two-qubit gates between different pairs of qubits. Each coupling structure may be associated with one pair of qubits coupled thereto in a one-to-one correspondence, so that two-qubit entangling gates between the qubits of these pairs may be performed in parallel. While a coupling structure, e.g. a resonator, allows in principle to apply multi-qubit entangling gates between more than two qubits coupled thereto, the fidelity of the multi-qubit gate is reduced compared to the fidelity of the two-qubit gate. Therefore, many quantum algorithms rely only on the ability to perform two-qubit entangling gates efficiently and are executed using only single-and two-qubit gates. In this case, the qubit-to-coupling structure ratio of 2 to 1 of the quantum chip of the example is optimal with respect to parallelism, as a two-qubit entangling gate may be implemented simultaneously between each pair of qubits that is coupled to and associated with one coupling structure. Quantum chips with unit cells in which more than two qubits are coupled to one coupling structure of the unit cell have an improved connectivity compared to quantum chips with unit cells in which only two qubits are coupled to the coupling structure of the unit cell. However, they do not provide an improved parallelism for executing quantum algorithms.

In another example, the unit cell may comprise more than two qubits, e.g., three, four, five or more qubits. Each of the qubits of the unit cell may be coupled to the at least one coupling structure in one example. Alternatively, when the unit cell comprises more than two qubits, there may be qubits of the unit cell which are not coupled to the at least one coupling structure. For example, there may be a first set of qubits of the unit cell comprising at least two qubits which are coupled to the at least one coupling structure of the unit cell and a second set of qubits of the unit cell without coupling to the at least one coupling structure. The qubits of the second set may, e.g., be coupled to the qubits of the first set, e.g., by direct qubit-qubit coupling in one example. In some examples this may allow for more parallelism in the execution of a quantum algorithm. For example, the qubits of the second set can be used to mediate the interaction between the qubits of the first set to mitigate the issue of parallelism loss in the case there are more than six qubits connected to one coupling structure.

In one example, there are three unit cells with only a single qubit of the qubits of the three adjacent unit cells coupled thereto. However, the invention is not limited to this. In another example, there may be more than three adjacent unit cells, e.g., four, five, six or more adjacent unit cells, with only a single qubit of the more than three adjacent unit cells coupled to the at least one coupling structure of each of the adjacent unit cells.

The pattern may be a repeating pattern in one example. In one example, the pattern may be a regular pattern.

The two-dimensional pattern of the unit cells comprising the qubits and the coupling structures may be arranged on a substrate in one example. The substrate may be integral in one example.

The quantum chip may comprise further elements, in particular means for implementing single- and two-qubit gates and readout means for reading out the state of the qubits.

In one embodiment of the quantum chip according to the first aspect of the present invention, there may be for each set of at least three adjacent unit cells of the pattern only a single qubit of the qubits of the at least three adjacent unit cells coupled to the at least one coupling structure of each of the three adjacent unit cells. Thereby, a particularly high connectivity between the qubits may be achieved without crossings of coupling structures. In an alternative embodiment of the quantum chip according to the first aspect of the present invention, there may be a plurality of sets of at least three adjacent unit cells having only a single qubit of the qubits of the at least three adjacent unit cells coupled to the at least one coupling structure of each of the three adjacent unit cells, and there may be another set of at least three adjacent unit cells having no or more than one qubit coupled to the coupling structure of the at least three adjacent unit cells.

In one embodiment, the qubits may be superconducting qubits and for at least one unit cell the at least one coupling structure may comprise a resonator, in particular a CPW (coplanar waveguide) resonator or a waveguide or any other signal-conducting transmission lines. In one example, the superconducting qubits may be transmons, unimons or fluxoniums, but the invention is not limited to this. In one example, all coupling structures of the unit cell may comprise a resonator, in particular a CPW resonator, a waveguide or any other signal-conduction transmission line. In one example, all coupling structures of all unit cells may comprise a resonator, in particular a CPW resonator, a waveguide or any other signal-conducting transmission line. The coupling structure may be used as a bus in one example. In another example, the coupling structure may be used as a logical element, e.g., by coupling the qubit to the coupling structure, the state of the qubits may be mapped into the coupling structure.

The coupling structure can also comprise a qubit. The qubit can be the same type of qubit as the other qubits present. The qubit can also be a different type of qubit. In this example, the qubit can be a central qubit connected to at least two other qubits.

In one example, the coupling structure may comprise a SQUID.

The resonator may be, for example, a superconducting coplanar waveguide resonator. Such a resonator is formed of a single conducting track with a pair of return conductors, one located on each side of the conducting track. Boundary conditions of either zero current or zero voltage are imposed at the ends of the conducting track, giving rise to a set of resonant frequencies that match the boundary conditions. In the case of capacitive coupling, the tunable couplers are located at positions along the resonator that correspond to the positions of voltage maxima of the electromagnetic standing wave that arises within the resonator. By scaling the length of the resonator, the number of maxima within the resonator can be increased, providing more locations at which qubits can be coupled to the resonator via tunable couplers. In another example, the coupling is an inductive coupling, and the tunable couplers are located at positions along the resonator that correspond to the positions of current maxima of the electromagnetic standing wave that arises within the resonator. The tunable couplers can be located either on the side or along the resonator. The resonator may extend along a path between the qubits coupled thereto. This configuration may allow to implement SWAP-operations between the qubits coupled thereto, and/or to implement a MOVE-operation between the qubits and the resonator in one example.

In a further expedient embodiment of the present invention, for at least one unit cell the at least one coupling structure may comprise a tunable coupler. The tunable coupler may enable to perform two-qubit gates between pairs of qubits selected among the qubits coupled thereto. This is an alternative solution to the coupling structure comprising a resonator. In one example, each coupling structure of the unit cell may comprise a tunable coupler. In another example, all coupling structures of the quantum chip may comprise a tunable coupler. However, there may also be examples where some of the coupling structures comprise a resonator and others comprise a tunable coupler.

In one embodiment of the quantum chip according to the first aspect of the present invention, the quantum chip may comprise at least one further qubit coupled to the at least one coupling structure of one or more unit cells. Thereby, the connectivity of the quantum chip may be further improved. The at least one further qubit may be the same type of qubit as the qubits of the unit cells. In particular, they may be superconducting qubits, e.g. transmons, fluxoniums or unimons. The at least one further qubit is not an element of one of the unit cells. In particular, the at least one further qubit may be coupled to the at least one coupling structures of a unit cell arranged at a boundary of the two-dimensional pattern in one example. In one example, the further qubit may be coupled to the at least one coupling structure of at least two adjacent unit cells.

There is no restriction regarding how the qubits and the coupling structures are coupled to each other, as long as the coupling structure provides connectivity between the qubits coupled thereto and thereby provides the possibility to implement two-qubit gates between any pair of qubits of the qubits coupled to the coupling structure while having no effect on the other qubits connected to the coupling structure, which can be considered as spectator qubits. The term “coupling” includes a direct coupling that is effective between qubit and coupling structure and an indirect coupling between qubit and coupling structure via an additional coupler that is effective between qubit and coupling structure. In one expedient embodiment, the quantum chip may comprise for at least one qubit a coupler, preferably a tunable coupler, providing the coupling between the qubit and one of the at least one coupling structures. In one advantageous example, all couplings between qubits and coupling structures are provided by couplers, preferably by tunable couplers. In particular, for each coupling between a qubit and a coupling structure there may be a coupler, preferably a tunable coupler, providing the coupling therebetween. In one example, the qubits may be frequency-tunable superconducting transmon qubits coupled to a coplanar waveguide transmission line in the quarter wave configuration as it is disclosed in M. Regner et. al, “A Superconducting Qubit-Resonator Quantum Process with effective All-to-All Connectivity”, arxiv 2503.10903, (2025).

In a further embodiment of the quantum chip according to the first aspect of the present invention, the qubits of the unit cells and the at least one further qubit may be arranged in a lattice structure, preferably in a hexagonal lattice structure or in a brick wall lattice structure, wherein for each unit cell the at least one coupling structure is arranged at one of the plaquettes of said lattice structure, and for each plaquette the qubits surrounding said plaquette are coupled to the at least one coupling structure arranged at said plaquette. When the qubits are arranged in the hexagonal or brick wall lattice structure, the arrangement may be such that there are no crossings between the coupling structures and the couplers coupling the qubits thereto. In this way, the quantum chip may have a high quality. In one example, the qubits may be arranged in a regular lattice structure. In particular, the lattice structure may be a regular hexagonal lattice structure or a regular brick wall lattice structure. In this case, the unit cell may have two qubits coupled to one coupling structure, the qubits of each unit cell may be arranged at neighboring vertices of the hexagonal lattice structure and one coupling structure may be arranged at each plaquette in one example. Each set of three adjacent unit cells may have a single qubit of the qubits of the three adjacent unit cells coupled to the coupling structure of each of the three adjacent unit cells. Further, in this configuration, each qubit may be coupled to at most three different coupling structures, and each qubit of one of the unit cells in the bulk (i.e., it is a qubit which is not arranged at the boundary of the configuration) may have connectivity with twelve other qubits via the three coupling structures to which it is coupled. There may be a plurality of further qubits so that for each coupling structure there are six qubits coupled thereto. The qubits of the unit cells may be arranged in the bulk or at the boundary of the qubit lattice. The further qubits may only be arranged at the boundary of the qubit lattice in one example. However, the invention is not limited to this.

In a further expedient example of the embodiment, each unit cell may comprise four qubits coupled to one coupling structure, and for each set of three adjacent unit cells there is only a single qubit of the qubits of the three adjacent unit cells coupled to the one coupling structure of each of the adjacent unit cells. The coupling structure of each unit cell may be arranged at two neighboring plaquettes of the hexagonal or brick wall lattice structure in one example.

In another embodiment of the present invention, said quantum chip may comprise for at least one pair of qubits an additional qubit-qubit coupler, preferably a tunable coupler, the qubits of the pair of qubits being coupled thereto. The pair of qubits may consist of two qubits in the same or in different unit cells, or it may consist of one qubit of one of the unit cells and one further qubit, or it may consist of first and second further qubits. The additional qubit-qubit coupler further improves the connectivity of the quantum chip.

In a further expedient embodiment of the present invention, the unit cells, the couplers, and/or the qubit-qubit couplers may be arranged in one plane. In this way, the quantum chip has a very compact structure and may not require the flip-chip architecture. In one example, the unit cells and the couplers may be arranged in a first plane and at least one qubit-qubit coupler may be arranged in a second plane.

In another expedient embodiment of the quantum chip of the present invention, the at least one coupling structure of each unit cell and/or the couplers and/or the qubit-qubit couplers are arranged free of crossings. In one example, all coupling structures, couplers and qubit-qubit couplers, if present, are arranged free of crossings. In one example of the embodiment, the unit cells and all couplers and qubit-qubit couplers (if present) may be arranged in the one plane, but the invention is not limited to this. The crossings may be avoided since there is only a single qubit of the at least three adjacent unit cells coupled to the at least one coupling structure of each of the at least three adjacent unit cells. “Free of crossings” may mean “free of crossings in a single plane” or “free of crossings in a plan view on the quantum chip” (meaning that there are also no out-of-plane crossings).

Alternatively, there may be crossings between the coupling structures, the couplers and/or the qubit-qubit couplers, either in-plane or out-of-plane (this may be due to elements being arranged in different planes.). In one embodiment of the quantum chip according to the first aspect of the present invention, at least one qubit-qubit coupler may comprise a long-range coupler extending along a path between the qubits of the pair of qubits while crossing the at least one coupling structure of at least one unit cell, at least one of the couplers and/or at least one other qubit-qubit coupler. When the crossings are in-plane, they may be realized by airbridges in one example. In another example, the crossings may be out-of-plane, e.g. due to the long-range coupler extending along the path in a different plane than the at least one coupling structure, the at least one coupler and/or the at least one qubit-qubit coupler. This may be realized, e.g., by use of the flip-chip technology.

In another embodiment, the quantum chip may comprise a long-range coupler between a first coupling structure of a first unit cell and a second qubit of a second unit cell or a second coupling structure of a second unit cell. This embodiment may require fewer long-range couplers to obtain the same connectivity compared to a quantum chip with long-range couplers only between qubits of different unit cells. In one example, the first and second unit cells are distant from each other, i.e., they are non-adjacent unit cells.

The long-range coupler is in particular a coupler that allows to connect qubits and/or coupling structures so as to provide connectivity beyond local connectivity. The long-range coupler may be understood as a non-local or near-local coupler. Preferably, the long-range coupler has a length that introduces only minimal cross-talk. In one example, the long-range coupler is a non-planar coupler. In one example, the long-range coupler may comprise a CPW resonator.

The quantum chip may comprise a plurality of patterns which are coupled to each other to thereby provide scalability. In one embodiment, said quantum chip may comprise another plurality of other unit cells arranged in another two-dimensional pattern, each other unit cell comprising at least one other coupling structure and at least two qubits coupled thereto, wherein there are at least three adjacent other unit cells with only a single qubit of the qubits of the at least three adjacent other unit cells coupled to the at least one other coupling structure of each of the at least three adjacent other unit cells, the two-dimensional patterns being spaced apart from each other, and the quantum chip may further comprise a connecting structure which is arranged between the two patterns and is coupled to at least one qubit and/or the at least one coupling structure, respectively other coupling structure, of each of the patterns. In one example, the other unit cells may be similar/identical to the unit cells, the other coupling structures may be similar/identical to the coupling structures, and/or the patterns may be similar and/or identical. Everything that was said above in relation to the two-dimensional pattern with its unit cells, coupling structures, qubits, etc. may also hold for the other pattern with its other unit cells, other coupling structure, qubits, etc. In particular, there may also be couplers, further qubits and qubits coupled to the other coupling structures and/or qubits of the other pattern, similar/identical as for the pattern and explained above. In particular, the two patterns are non-adjacent patterns. I.e., the first pattern has a first boundary and the second pattern has a second boundary, and the first and second boundaries do not have a region or point in common. In particular, the first and second patterns have no qubit in common. In other words, there is a gap of a certain size between the boundaries of the two patterns. In one example, the connecting structure is arranged in this gap.

The two patterns may be arranged in the same plane in one example. In particular, the two patterns may be arranged on a single substrate in one example. In another example, the patterns may be arranged on two separate substrates. In another example, the patterns may be arranged in different planes. In yet another example, the quantum chip may comprise several other patterns similar to the two-dimensional pattern, and the patterns may be connected with each other by connecting structures. The connection may be in a chain-like configuration in one example. I.e., the patterns are arranged in a chain and neighboring patterns are connected by a connecting structure. Alternatively, all patterns may be coupled pairwise with each other in one example. The connecting structures may all be identical, or they may be different from each other. In one example, all patterns may be arranged in different planes or different substrates, more than 2.

In yet another embodiment of the quantum chip according to the first aspect of the present invention, said connecting structure may comprise a plurality of connector qubits arranged in a two-dimensional connector lattice structure with nearest-neighbor coupling, and connector qubits at a boundary of the connector lattice structure may be coupled to at least one qubit and/or the at least one coupling structure, respectively the at least one other coupling structure, of unit cells, respectively other unit cells, of each of the patterns at respective boundaries thereof. Thereby, an efficient coupling of the patterns may be obtained. The connector qubits may be the same type of qubits as the qubits of the patterns in one example. In another example, the connector qubits may be arranged in a square lattice configuration. The quantum chip according to the embodiment may comprise for at least some, and preferably for all qubits of the two patterns a read-out resonator for the read-out of the qubits. However, the connecting structure may not comprise any read-out resonators in certain examples.

In one embodiment of the quantum chip according to the first aspect of the present invention, the quantum chip may further comprise at least one region, the at least one region comprising a plurality of qubits having connectivity between themselves, wherein there is connectivity between qubits of the at least one region and qubits of the two-dimensional pattern, wherein the connectivity between qubits of the at least one region is different than the connectivity between qubits of the two-dimensional pattern. Preferably, the at least one region is configured as a magic state factory in one example. In one example, the at least one region may be adjacent to the pattern. In one example, the at least one region may comprise first and second regions which are spaced apart from each other. In one example, the first and second regions may be arranged at opposing edges of the two-dimensional pattern, but the invention is not limited to this. In a further example, the at least one region may comprise three, four or more regions which are spaced apart from each other. When the at least one region comprises at least two regions which are spaced apart from each other, there is connectivity between qubits of each of the regions, but not between qubits in different regions in one example. In another example, the at least one region may be a single region which surrounds the two-dimensional pattern of unit cells, and preferably completely surrounds the two-dimensional pattern. The connectivity between the qubits of the at least one region may be provided by qubit-qubit couplers connecting pairs of qubits or by coupling structures connecting a plurality of qubits in one example. In one example, the qubits of the at least one region may be arranged on the same plane as the two-dimensional pattern, but the invention is not limited to this. In one example, the qubits of the at least one regions may be the same type of qubits as the qubits of the two-dimensional pattern. The connectivity between the qubits of the at least one region and the qubits of the two-dimensional pattern may be such that magic state injection may be performed. In particular, not all but only a subset of the qubits of the at least one region may be connected with not all but only a subset of the qubits of the two-dimensional pattern.

A magic state factory is a subsystem of the quantum chip configured to prepare magic states, and in particular T-states. Magic state factories require a large amount of physical qubits to be used in distillation protocols generating high-fidelity magic states. The magic states may then be used (or consumed) in a quantum error correction cycle implemented on the qubits of the two-dimensional pattern of the quantum chip. Further details are disclosed e.g. in Joe O′Gorman and Earl T. Campbell, “Quantum computation with realistic magic-state factories,” Phys. Rev. A 95, 032338 (2017). In many quantum error correcting protocols, the quantum error correcting code is suitable for implementing Clifford gates between logical qubits of the code. While Clifford gates are not universal, magic states may be used to obtain a universal gate set by magic state injection. Quantum error correction using magic states generally requires two codes, one for generating the magic states and one for implementing the Clifford gates. In the quantum chip according to the embodiment, the code for generating the magic states may be implemented on the qubits of the first and second regions, and the quantum error correcting code for implementing the Clifford gates may be implemented on the qubits of the two-dimensional pattern. Magic state factories and their importance for Quantum Error Correction are known in the art, see, e.g., A. Holmes “Quantum and classical algorithms and optimizations enabling practical quantum computation”, PhD Thesis, University of Chicago (2020) or J. O′Gorman and E. T. Campbell, “Quantum computation with realistic magic-state factories”, Phys. Rev. A 95, 032338.

According to a second aspect of the present invention, there is provided a method of performing quantum computation, in particular quantum simulation of a fermionic system, or implementing a quantum error correcting code, more in particular, a quantum Low-Density Parity-Check code, on a quantum chip according to the first aspect of the present invention. As the quantum chip according to the first aspect of the present invention has a high connectivity, quantum computation may be efficiently performed on the quantum chip by use of the connectivity of the chip. In particular, due to the high connectivity of the quantum chip, the number of SWAP-gates and/or MOVE-gates required to perform a certain quantum computing application may be reduced compared to the case when this quantum computing application is performed on a quantum chip of the prior art.

In particular, quantum Low-Density Parity-Check (qLDPC) codes which have favorable properties for quantum error correction require non-local interactions between qubits and/or interactions between more than two qubits depending on the weights of the stabilizers. In particular, stabilizers in a surface code have weight 4, while most of good qLDPC codes have stabilizer weight at least 6. Having an enhanced connectivity compared to the prior art, as in the quantum chip according to the first aspect of the present invention, allows for more flexibility in designing such codes that may be implemented without the need for any SWAP or MOVE operations on the quantum chip. For example, so-called generalized bicycle error-correcting codes (see e.g. N. Koukoulekidis et. al, “Small Quantum Codes from Algebraic Extensions of Generalized Bicycle Codes”, arxiv:2401.07583v1, Alexey A. Kovalev and Leonid P. Pryadko, “Quantum Kronecker sum-product-low-density parity-check codes with finite rate”, Physical Review A, 88(1):012311, 2013 may be implemented on the quantum chip according to the first aspect of the present invention with a minimal SWAP-gate or MOVE-gate overhead. Notably, SWAP-gates or MOVE-gates could be performed between syndrome qubits only, which significantly improves the error-correcting properties of the codes. One example of a qLDPC code requiring a minimum number of MOVE-gates and only one long-range (near-local) coupler per stabilizer operator on a quantum chip according to the first aspect of the present invention with a unit cell comprising two qubits is presented below with reference to FIG. 10. Each stabilizer operator of weight 6 may be measured by use of the connectivity between each of five data qubits and each syndrome qubits provided by the coupling structures, two MOVE-gates, and one connectivity provided by a long-range coupler. These codes requiring minimum at most four MOVE-gates and one near-local coupler are called DenseHex-friendly codes.

Further, there is a class of well-performing quantum subsystem codes (see e.g., S. Bravyi et. al., “Subsystem surface codes with three-qubit check operators” arvix:1207.1443, O. Higgott et. al, “Subsystem codes with high thresholds by gauge fixing and reduced qubit overhead”, arxiv:2010.09626) with thresholds comparable to the surface code. These codes have three-qubit checks (stabilizers), that need to be measured and which would require a diagonal connectivity between the syndrome and data qubits. This means that one cannot immediately realize these codes on a standard quantum chip with qubits arranged in a square lattice configuration having nearest-neighbor couplings, while the quantum chip according to the present invention provides the desired connectivity.

In local fermionic mappings one is interested in measuring stabilizers, which normally requires to apply two-qubit gates between check-qubits and all other qubits involved in a stabilizer. Typically, the size of stabilizers is around 6-12, which means that the connectivity of check qubits is beyond what is possible within a square lattice with nearest-neighbor coupling where each qubit has connectivity with (at most) four qubits. As explained above, there are embodiments of the quantum chip according to the first aspect of the present invention wherein each bulk qubit has connectivity with 12 qubits. This allows for a number of mappings to be implemented without the need for SWAP operations or MOVE operations, notably the low-weight Derby-Klassen mapping which requires a connectivity of 8 for the qubits. Examples of encodings that may be implemented without or only a reduced number of SWAP-gates and/or MOVE-gates are disclosed, e.g., in M. Algaba et. al, “Low-depth simulations of fermionic systems on square-grid quantum hardware”, Quantum 8, 1327 (2024) and F. Šimkovic et. al, “Low-Weight High-Distance Error Correcting Fermionic Encodings”, arxiv:2402.15386v1, also published in Phys. Rev. Research 6, 043123 (2024).

With regard to quantum simulation of fermionic systems on a quantum chip comprising qubits, most fermionic models from condensed matter physics and quantum chemistry have two spin-species (up/down) per lattice site. The interactions between fermionic modes of the same species are typically different to the ones between species. If one considers the example of the paradigmatic Fermi-Hubbard model on the square lattice, there are hopping terms between modes of the same spin, but only density-density interactions between modes of opposite spin. This allows to effectively decompose the problem into two square sublattices which have an additional connectivity between two modes of opposite spin on the same lattice. Such connectivity may be embedded into the current architecture and as a result one may gain roughly a factor two on the circuit depth compared to a standard square QPU (Quantum Processing Unit) due to the parallel execution of gates. There is also a saving in the number of gates, as there is no need to implement any SWAP or MOVE gates to bring opposite-spin modes next to each other. This concept may also be applied to different and more complex models from solid state physics.

The quantum chip of the first aspect of the present invention has at least two qubits in each unit cell that are coupled to the at least one coupling structure of the same unit cell which is favorable for parallelism, and it is possible to optimize the quantum computation with respect to two-qubit gates that may be implemented in parallel on the quantum chip. Thereby, quantum computation may be carried out more efficiently than in the prior art.

In one embodiment of the method according to the second aspect of the present invention, said method may comprise an implementation of a plurality of two-qubit gates between a plurality of pairs of qubits, wherein for each pair the qubits of said pair are coupled to the same coupling structure or are coupled by the additional qubit-qubit coupler. In this way, a particularly large reduction of the number of SWAP-gates or MOVE-gates required to implement the quantum computing application may be obtained, as the quantum gates may be implemented directly by use of the connectivity of the quantum chip. For each pair of qubits, the qubits of the pair may belong to the same unit cell, to adjacent unit cells, or at least one qubit of the pair may be a further qubit.

In one expedient embodiment of the method according to the second aspect of the present invention, the quantum computation may comprise the implementation of a quantum error correcting code, in particular a sparse quantum error correcting code, even more particular a quantum Low-Density Parity-Check code (or qLDPC code), said quantum error correcting code being defined by a Parity-Check matrix, and said method may further comprise:
designating, among the qubits of the quantum chip, a plurality of data and syndrome qubits for the implementation of the quantum error correcting code with a short quantum error correction cycle according to the Parity-Check matrix;
initializing each of the plurality of data and syndrome qubits in a predetermined initial state;
executing the quantum error correction cycle on the quantum chip, wherein the execution comprises an error detection and/or correction step which comprises implementation of quantum gates on the data and syndrome qubits followed by a measurement of the state of the syndrome qubits to thereby obtain a plurality of syndrome bits associated with said cycle, the syndrome bits being indicative of an error, wherein the implementation of the quantum gate comprises implementation of at least one two-qubit gate on a pair of qubits coupled to the same coupling structure.

As the quantum chip according to the first aspect has a high connectivity and may enable to implement many two-qubit gates in parallel, the quantum error correcting code may be implemented efficiently on said quantum chip. Furthermore, the implementation of the two-qubit gate applied on the pair of qubits coupled to the same coupling structure does not require any SWAP-gates or MOVE-gates.

In one embodiment, the quantum chip may comprise at least one additional ancillary qubit, wherein there is a coupling structure between at least one qubit of the plurality of qubits of the two-dimensional pattern and the ancillary qubit. This embodiment is preferable when the ancillary qubit is not for use as a logical qubit in a quantum computation. For example, when the quantum chip is used for the implementation of a quantum error correcting code, syndrome qubits for the storing of syndrome information may be required. In particular, the ancillary qubit may be used as a flag qubit. In one example, there is an ancillary qubit for at least one, and in particular for each stabilizer operator of the quantum error correction code. Thereby, fault-tolerant quantum error correction may be enabled. The use of flag qubits is explained, for example, in R. Chow et al., Quantum error correction with only two extra qubits, Phys. Rev. Lett., 2021:050502, 2018.

Sparse Quantum Error Correction (QEC) codes such as the quantum Low-Density Parity-Check Codes are highly interesting as they require only low-weight parity checks and have a non-vanishing rate and relative minimum distance as the qubit count scales up. In Panteleev et al., “Degenerate quantum LDPC codes with a good code performance”, arXiv: 1904.02703, 2019 and N Koukoulekidis et. al, “Small Quantum Codes from Algebraic Extensions of Generalized Bicycle Codes”, arXiv:2401.07583 it is disclosed that it is possible to have good code performance using small, degenerate stabilizers so that qLDPC codes may be preferable over other QEC codes. That is, a comparable noise threshold and minimum distance may be possible by using qLDPC codes when compared with bi-dimensional lattice-based stabilizer codes, such as standard surface codes. Up to now, the limited connectivity of superconducting/semiconducting quantum chips often precluded the usage of efficient qLDPC codes. Due to the enhanced connectivity of the quantum chip according to the first aspect of the present invention compared to prior-art quantum chips, an efficient implementation of the QEC codes, in particular of qLDPC codes may be possible. In particular, the gate overhead and the runtime may be significantly reduced by implementing two-qubit gates between qubits coupled to the same coupling structure, and by implementing as many gates in parallel as possible.

According to the method of the second aspect of the present invention, syndrome and data qubits are designated among the qubits of the quantum chip in a way that allows for an efficient implementation of the quantum error correcting code on the quantum chip. A general QEC cycle may require the implementation of single-qubit gates and two-qubit gates. Thus, for the implementation of the quantum error correcting code, the quantum chip may be operative to implement single-qubit gates on the qubits and to perform measurements, in particular single-qubit measurements, and, in particular, in the computational basis. Two-qubit gates between the pairs of qubits may be implemented by use of the coupling structures, and, if present, the additional qubit-qubit couplers. When there is no connectivity between qubits of the pairs of qubits, further operation, like SWAP-gates or MOVE-gates, may be required.

The data and syndrome qubits are designated in accordance with the parity check matrix of the quantum error correcting code and by considering the connectivity of the quantum chip such that the quantum error correcting code is implementable on the quantum chip with a short quantum error correction cycle according to the parity check matrix. I.e., the syndrome and data qubits are designated such that the time required for the implementation of one quantum error correction cycle is short, in particular shorter than a desired time, and in certain examples even minimal. In one example, the error correction cycle is less than 2 μs, preferably less than 1.5 μs.

In one example, the data qubits are initialized such that they encode a predetermined logical qubit state. This may be achieved by preparing all data qubits in a known state. In one example, this may be achieved by preparing all data qubits in the |0>state, and by applying a sequence of quantum gates to the data qubits, in particular a sequence of single- and two-qubit gates. In a further example, all syndrome qubits may be initialized in the |0>state.

The execution of the quantum error correction cycle comprises an error detection step which comprises an implementation of a quantum gate and a measurement of the state of the syndrome qubit. In general, a sequence of single-and two-qubit gates is applied to the data and syndrome qubits followed by a measurement of the state of the syndrome qubits, in particular in the computational basis. In one example where the quantum error correcting code is a stabilizer code, the quantum error correction cycle may implement a measurement of the stabilizer operators. The quantum chip used for the implementation of the method may have a connectivity which allows for an efficient implementation of certain kinds of quantum error correcting codes.

In one expedient embodiment, the method according to the second aspect of the present invention may comprise a parallel application of a plurality of quantum gates on a plurality of pairs of qubits, wherein for each pair of qubits the qubits of the pair of qubits are coupled to the same coupling structure. Thereby, a high level of parallelism may be achieved, and the quantum computation may be implemented efficiently.

In one further embodiment of the method according to the second aspect of the present invention, the quantum chip may comprise the pattern and the other pattern, as explained above, and the method may comprise an implementation of a logical qubit gate, wherein said implementation comprises an implementation of a single-qubit gate and/or a two-qubit gate on at least one of the data qubits using the connecting structure connecting the two patterns of the two-dimensional pattern and the other two-dimensional pattern of the quantum chip.

In yet another embodiment of the method according to the second aspect of the present invention, the method is a method of implementing a quantum error correcting code, one or more logical qubits and/or memories may be created from the plurality of qubits by encoding according to the quantum error correcting code, wherein in particular some of the qubits of a respective logical qubit or memory are part of a respective plurality of qubits coupled to the same coupling structure. Thereby, at least some of the qubits of a logical qubit or a memory have connectivity due to their coupling to the same coupling structure. This increases the performance for implementing the quantum error correcting code on the quantum chip according to the first aspect of the present invention compared to the prior art.

In another embodiment of the method according to the second aspect of the present invention, said method may comprise an application of a leakage reduction unit scheme. The leakage reduction unit (LRU) scheme allows to reduce qubit leakage errors present in the quantum computation. An example of the LRU scheme is presented, e.g. in J. F. Marques et. al, “All-Microwave Leakage Reduction Units for Quantum Error Correction with Superconducting Transmon Qubits”, Phys. Rev. Lett. 130, 250602 (2023).

In another embodiment, the method may further comprise repeatedly executing the quantum error correction cycle to thereby obtain a plurality of syndrome bits in each cycle, post-processing the plurality of syndrome bits of each cycle, storing the syndrome bits on a memory, and obtaining error information indicative of an error associated with the respective cycle using the syndrome bits of this cycle and of the previous cycles. In this embodiment, an error correction step may be only applied once, when all cycles are executed, and not after every execution of the QEC cycle as it is the case for active error correction. This approach is also called passive error correction and may be useful when the quantum chip is used as a quantum memory. Passive quantum error correction may be efficiently executed by the quantum chip due to its enhanced connectivity of the qubits and the possibility to implement many two-qubit gates in parallel. Post-processing may be executed by a classical computer. Also in this embodiment, an error correction step may be only applied several times, just before the execution of a logical non-Clifford gate.

In one example of the above embodiment, the method may further comprise an implementation of a logical operation with assistance from classical postprocessing of the syndrome data. See, e.g., as a reference for implementing logical operations E. Swaroop et al, “Universal adapters between quantum LDPC codes”, arXiv:2410.03628, 2024.

In yet another embodiment, the method may further comprise, during at least one quantum error correction cycle, performing a dynamical decoupling sequence on idling qubits to thereby reduce decoherence. In this way, errors in the execution of the QEC cycle may be suppressed.

One embodiment includes a method performing quantum computation, in particular quantum simulation of a fermionic system or implementing quantum error correcting code, more in particular a quantum Low-Density Parity Check code, on a quantum chip according to anyone of the preceding claims. In some embodiments, the method includes an application of a leakage reduction unit scheme. In some embodiments, the method includes repeatedly executing the quantum error correction cycle to thereby obtain a plurality of syndrome bits in each cycle, post-processing the plurality of syndrome bits of each cycle, storing the syndrome bits on a memory and obtaining error information indicative of an error associated with the respective cycle using the syndrome bits of this cycle and of the previous cycles. In some embodiments, the method includes an implementation of a logical operation with assistance from classical post-processing of the syndrome data. In some embodiments, the method includes, during at least one quantum error correction cycle, performing a dynamical decoupling sequence on idling qubits to thereby reduce decoherence.

### BRIEF DESCRIPTION OF THE DRAWINGS

In the following, the invention will be described in greater detail by way of example with reference to the drawings, in which:

FIG. 1 is a schematic representation of a first embodiment of a quantum chip according to the first aspect of the present invention;

FIG. 2 is a schematic representation of a second embodiment of a quantum chip according to the first aspect of the present invention;

FIG. 3 is an illustration of a connectivity graph of the quantum chip according to the second embodiment shown in FIG. 2;

FIG. 4a-4e indicate pairs of qubits of the quantum chip according to the second embodiment shown in FIG. 2 between which two-qubit gates may be implemented in parallel;

FIG. 4f indicates pairs of qubits of a modification of the quantum chip according to the second embodiment shown in FIG. 2 between which two-qubit gates may be implemented in parallel, said quantum chip comprising additional qubit-qubit couplers;

FIG. 5 is a schematic representation of a third embodiment of a quantum chip according to the first aspect of the present invention;

FIG. 6 is a schematic representation of a fourth embodiment of a quantum chip according to the first aspect of the present invention;

FIG. 7 is a schematic representation of a fifth embodiment of a quantum chip according to the first aspect of the present invention;

FIG. 8 is a schematic representation of a sixth embodiment of a quantum chip according to the first aspect of the present invention.

FIG. 9 is a schematic representation of a seventh embodiment of a quantum chip according to the first aspect of the present invention.

FIG. 10 is a schematic representation of the quantum chip according to the first aspect of the present invention on which a measurement of stabilizer operators of a quantum Low Density Parity Check code with weight 6 is carried out;

FIG. 11 is a flowchart of a first embodiment of a method of implementing quantum error correction on a quantum chip according to the second aspect of the present invention;

FIG. 12 is a flowchart of a second embodiment of a method of implementing quantum error correction on a quantum chip according to the second aspect of the present invention;

FIG. 13 a flowchart of an embodiment of a method of implementing a fault-tolerant quantum computation on a quantum chip according to the second aspect of the present invention, wherein the quantum chip comprises a region configured as a magic state factory.

### DETAILED DESCRIPTION

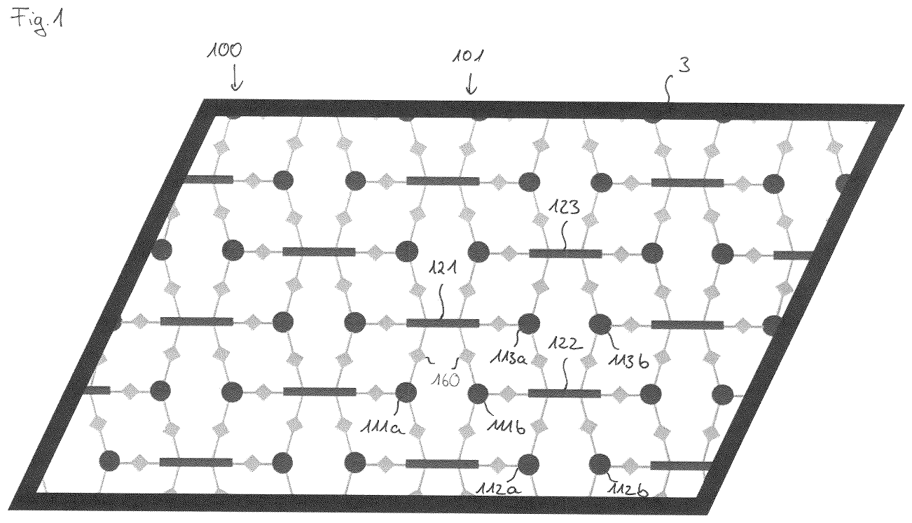

FIG. 1 is a schematic representation of a first embodiment of a quantum chip 100 according to the first aspect of the present invention. The quantum chip 100 comprises a plurality of qubits (filled circles), a plurality of coupling structures (thick, solid line), for example each comprising a resonator, for example a CPW resonator, a waveguide or other signal-conducting transmission line and a plurality of tunable couplers (squares and thin lines) each coupling one qubit to one of the coupling structures. All qubits, coupling structures and tunable couplers are arranged in one plane, preferably on a substrate. In one example of the first embodiment, the qubits are superconducting qubits. The qubits are arranged on the vertices of a two-dimensional regular hexagonal lattice.

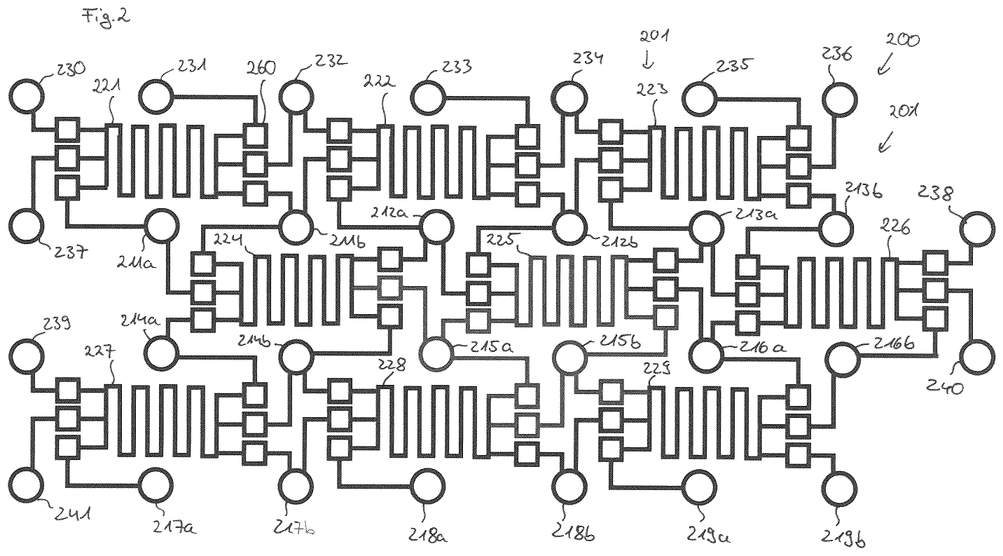

The boundary region 3 of the quantum chip 100 is schematically represented with a black frame. The coupling between qubits and coupling structures at the boundary region 3 may be different from that in the bulk but it is not limited to being different. An example for the coupling at the boundary will be explained below with reference to FIGS. 2, 4f and 8. However, these are only illustrative examples which do not limit the invention.

As it is depicted in FIG. 1, the quantum chip 100 comprises a plurality of unit cells arranged in a two-dimensional pattern 101, each comprising a coupling structure 121, 122, 123, and two qubits 111a,b, 112a,b, 113a,b coupled thereto. In FIG. 1, the qubits and coupling structures of only three unit cells are provided with reference signs to increase the legibility of the figure. More specifically, a first unit cell comprises two first qubits 111a, 111b coupled to a first coupling structure 121, a second unit cell comprises two second qubits 112a, 112b coupled to a second coupling structure 122, and a third unit cell comprises two third qubits 113a, 113b coupled to a third coupling structure 123. Coupling between each qubit and one of the coupling structures 121, 122, 123 is by a tunable coupler 160 (only two of which are provided with a reference sign in FIG. 1 to improve legibility). The first, second and third unit cells are adjacent to each other. Furthermore, out of the first, second and third qubits 111a, b, 112a, b, 113a, b of the three adjacent first, second and third unit cells only the third qubit 113a is coupled to the first, second and third coupling structures 121, 122, 123 of the three adjacent unit cells.

As one may take from FIG. 1, each qubit in the bulk is coupled to three coupling structures and has thereby connectivity with twelve qubits. Thus, a quantum chip having a high connectivity is provided. Furthermore, there are no crossings between coupling structures and tunable couplers, so that the chip does not require airbridges or the flip chip technology and has a good quality.

The quantum chip 100 of the first embodiment has a qubit-to-coupling structure ratio of 2 to 1. As has been explained above in the general part of the specification, such a ratio is optimal for parallel implementation of two-qubit gates during the execution of a quantum algorithm.

FIG. 2 is a schematic representation of a quantum chip 200 according to a second embodiment of the present invention. The quantum chip 200 comprises nine unit cells, each comprising a coupling structure 221, 222, 223, 224, 225, 226, 227, 228, 229, and two qubits 211a,b, 212a,b, 213a,b, 214a,b, 215a,b, 216a,b, 217a,b, 218a,b, 219a,b coupled to the coupling structure of its unit cells (first unit cell: qubits 211a,b, coupling structure 221; second unit cell: qubits 212a,b, coupling structure 222; third unit cell: qubits 213a,b, coupling structure 223; fourth unit cell: qubits 214a,b, coupling structure 224; fifth unit cell: qubits 215a,b, coupling structure 225; sixth unit cell: qubits 216a,b, coupling structure 226; seventh unit cell: qubits 217a,b, coupling structure 227; eights unit cell: qubits 218a,b, coupling structure 228; nineth unit cell: qubits 219a,b, coupling structure 229). The unit cells are arranged in a two-dimensional pattern 201. The unit cells are equivalent in the number of qubits coupled to their respective coupling structures, but they differ in terms of the relative position of qubits and resonators.

The quantum chip 200 also comprises twelve further qubits 230, 231, 232, 233, 234, 235, 236, 237, 238, 239, 240, 241, each coupled to one or two coupling structures.

For each qubit of the quantum chip 200, the coupling between the qubit and each coupling structure to which it is coupled is provided by a tuneable coupler 260 (open square and connecting lines; only one tunable coupler is provided with a reference sign in FIG. 2 to improve legibility). There are six tuneable couplers for each coupling structure, as each coupling structure has six surrounding qubits coupled thereto.

All qubits, all coupling structures and all tunable couplers are arranged in one plane, preferably on a substrate. In one example of the second embodiment, the qubits are superconducting qubits. The qubits are arranged in a two-dimensional brick wall lattice structure. The coupling structures 221-229 are arranged at the plaquettes of the lattice structure.

As one may take from FIG. 2, each qubit in the bulk (i.e., qubits 211b, 212a, 212b, 213a, 214b, 215a, 215b, 216a) is coupled to three coupling structures 221, 222, 223, 224, 225, 226, and has thereby connectivity with twelve qubits. Thus, the quantum chip 200 has high connectivity. The connectivity for the qubits at the boundary of the two-dimensional pattern (qubits 211a, 213b, 214a, 216b, 217a, 217b, 218a, 218b, 219a, 219b and the further qubits 230-241) is lower than for the qubits in the bulk but it is at least five. There are no crossings between coupling structures and tunable couplers, so that the quantum chip 200 does not require airbridges or the flip chip technology.

The brick wall lattice structure of the quantum chip 200 of the second embodiment may be transformed into the hexagonal lattice structure of the quantum chip 100 of the first embodiment and vice versa by moving the locations of the qubits while keeping the coupling between the qubits and the coupling structures.

For the qubits and coupling structures in the bulk, the qubit-to-resonator ratio is 2 to 1 which is optimal for parallel implementation of two-qubit gates during the execution of a quantum algorithm as has been explained above in the general part of the description.

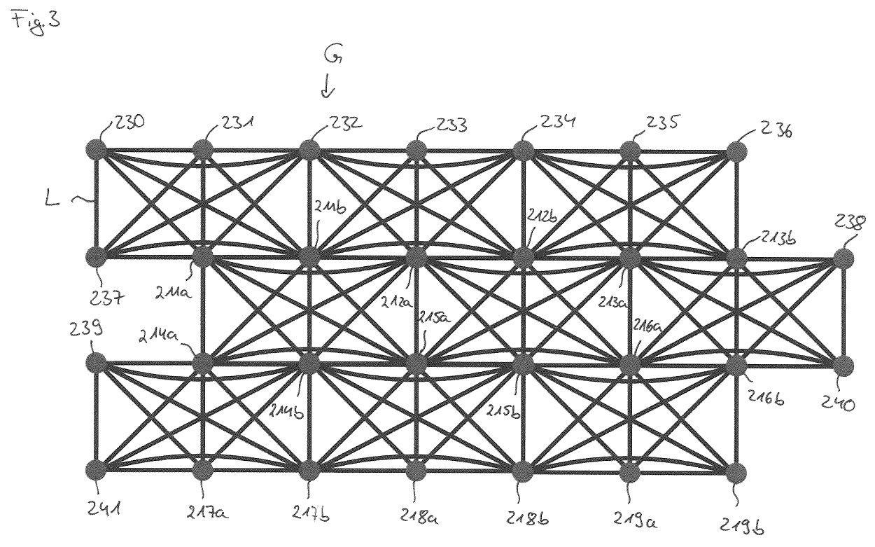

FIG. 3 is an illustration of a connectivity graph G of the quantum chip 200 according to the second embodiment shown in FIG. 2. The circles represent the qubits 211a-219b, 230-241 of the quantum chip 200, and corresponding qubits and circles in FIGS. 2 and 3 are provided with the same reference signs. For each pair of qubits having connectivity there is a line L connecting the qubits of said pair (only one line is provided with a reference sign in FIG. 3 to increase legibility). As one may take from FIG. 3, each qubit in the bulk has connectivity with 12 other qubits. The connectivity is reduced for qubits at the boundary, but each boundary qubit is connected with at least five qubits. The quantum chip 100 according to the first embodiment has a similar connectivity graph as the quantum chip 200 of the second embodiment.

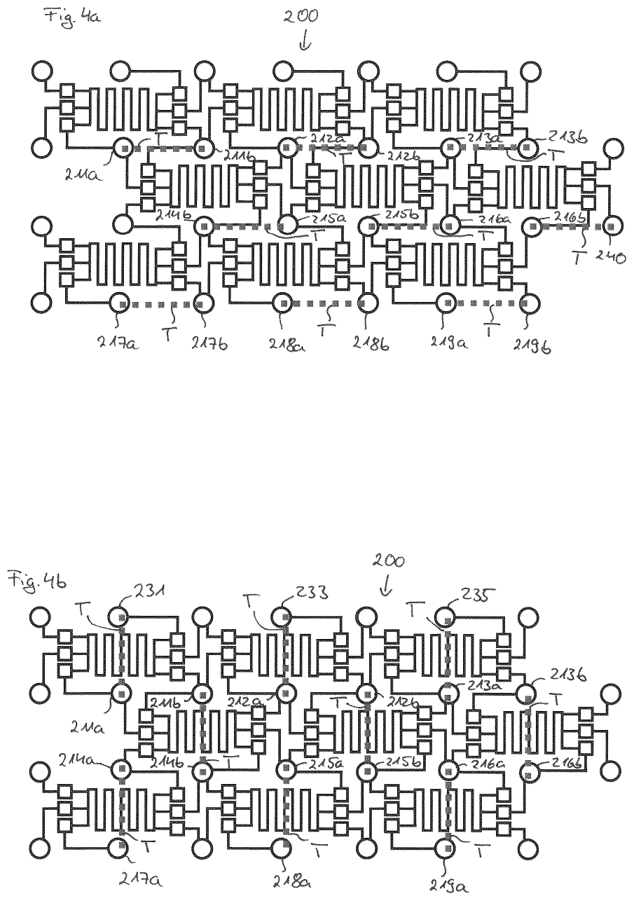

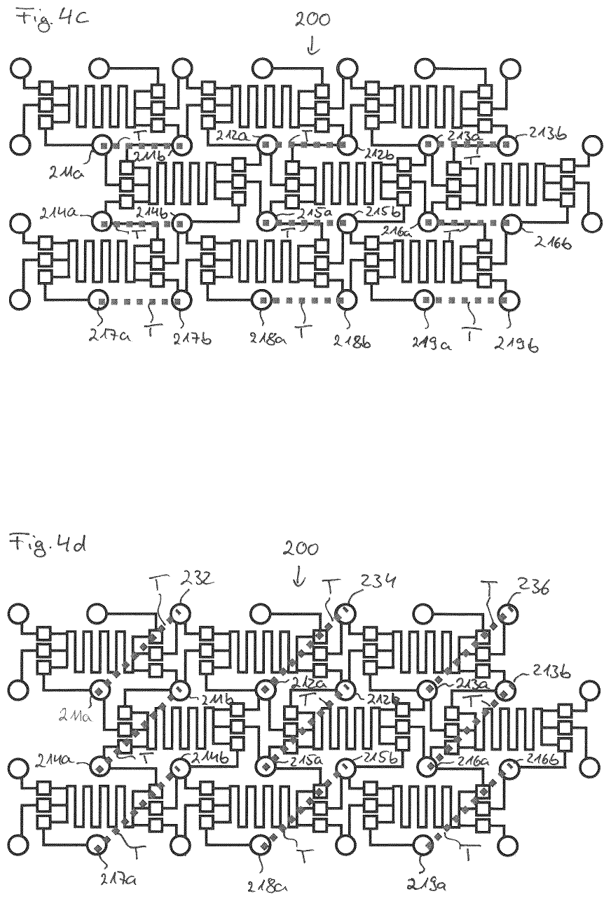

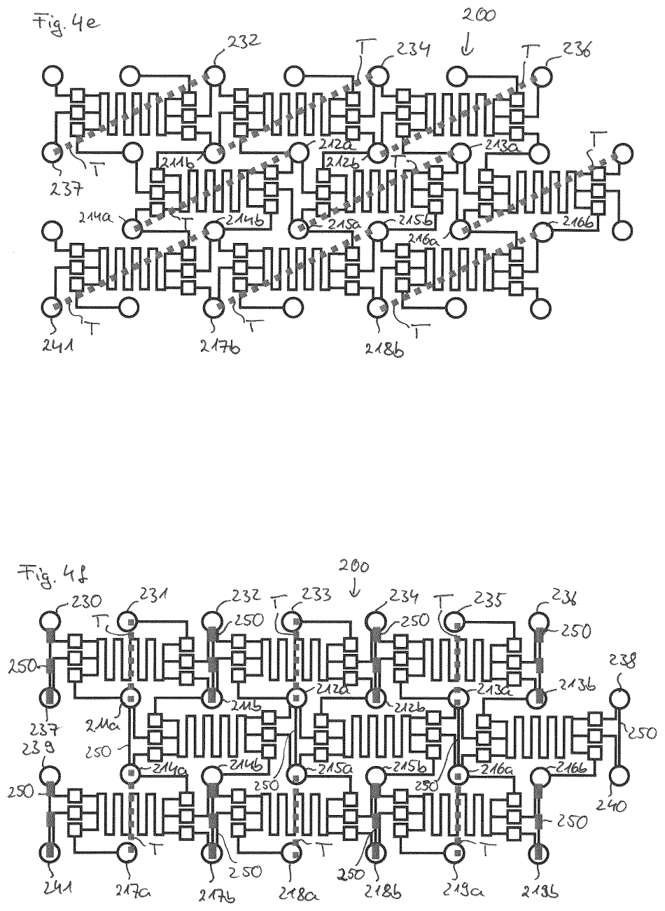

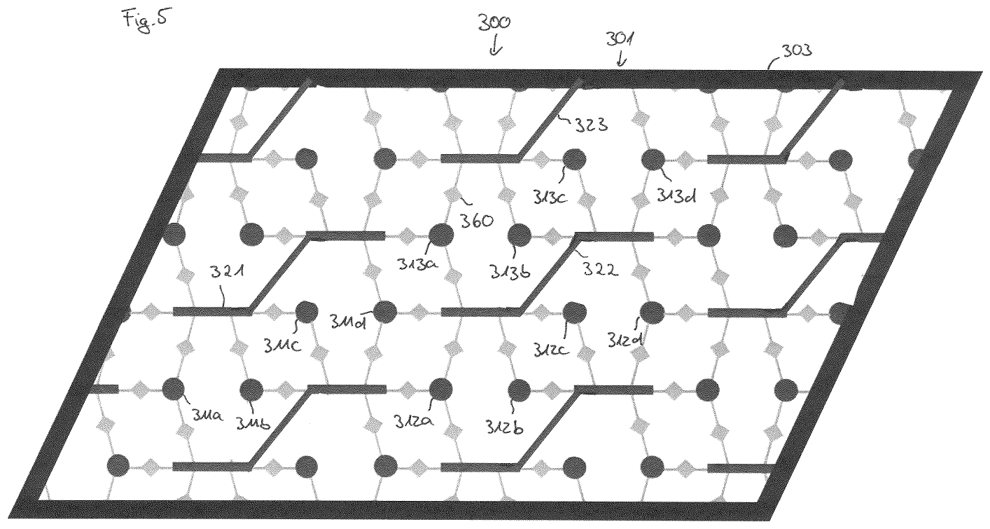

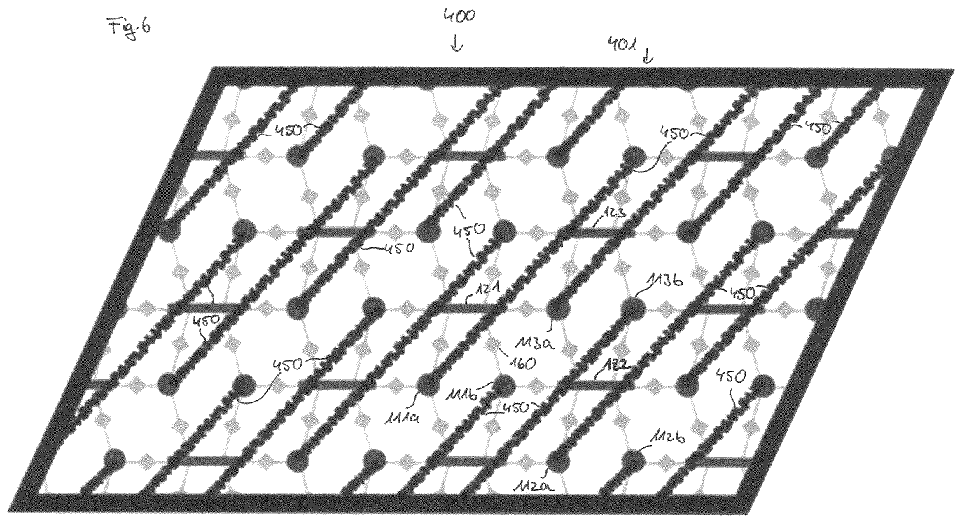

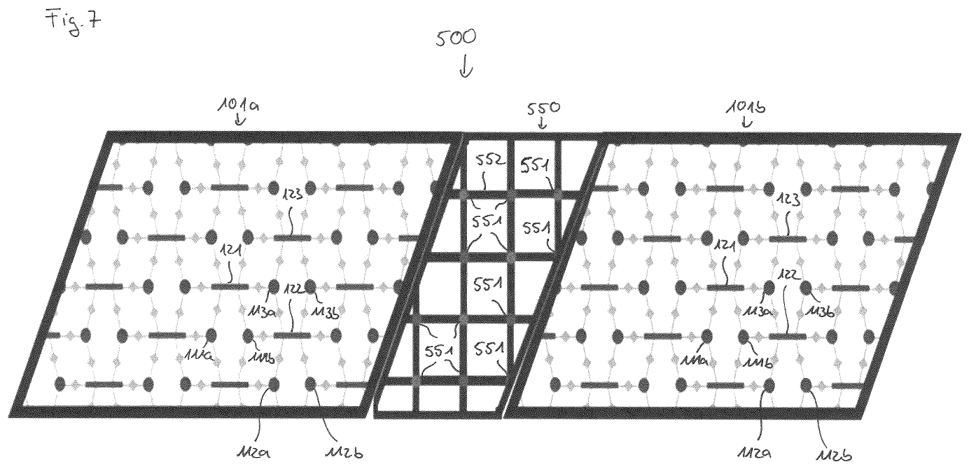

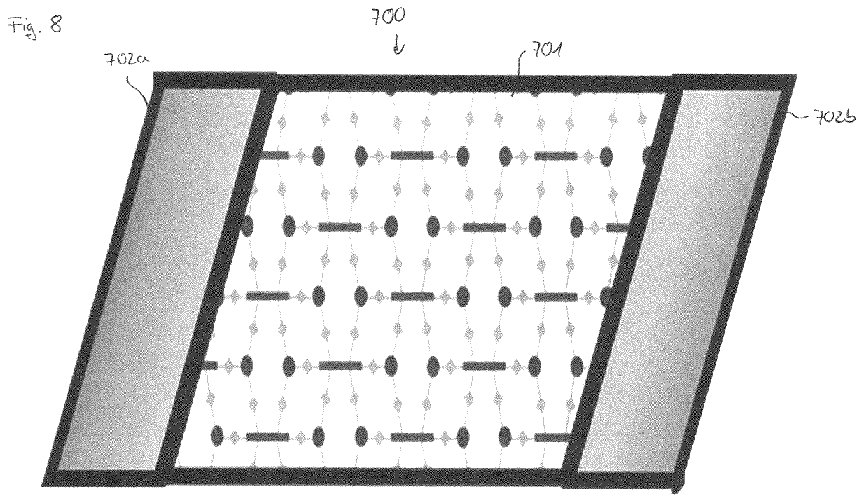

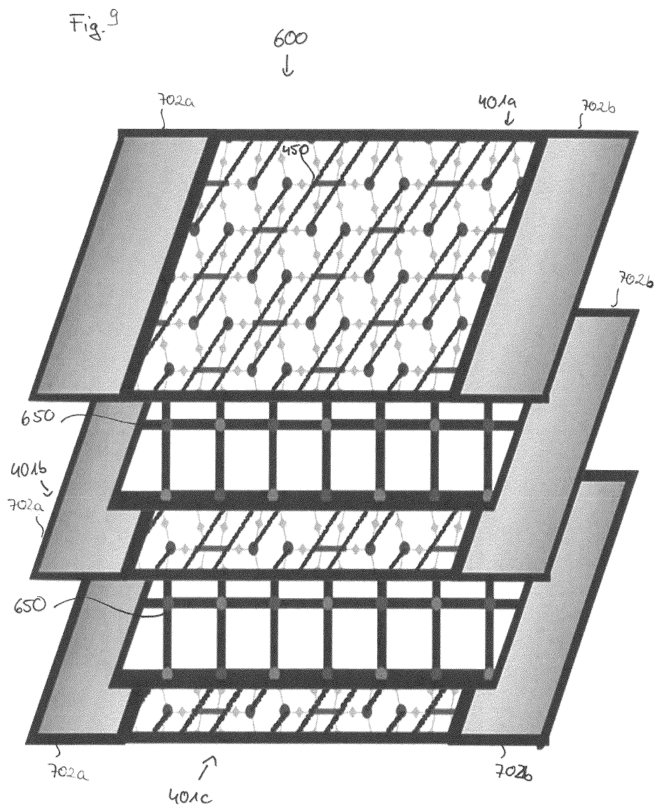

Generally, it is favorable when a quantum chip allows for a parallel application of as many two-qubit gates as possible as this may allow for an efficient implementation of quantum computation and allows to decrease errors from idling qubits. The quantum chips 100 and 200 according to the first and second embodiments allow for the parallel implementation of a variety of different configurations of quantum gates at it is exemplary represented in FIGS. 4a-4f.

Each of FIGS. 4a-4e is a schematic representation of the quantum chip 200 according to the second embodiment shown in FIG. 2. In each of FIGS. 4a-4e, pairs of qubits between which two-qubit gates may be applied in parallel are linked by a line T and only those qubits are provided with reference signs to increase legibility For example, FIGS. 4d and 4e show that the quantum chip 200 provides connectivity beyond nearest neighbors.

FIG. 4f is a schematic representation of a quantum chip 200′ according to a modification of the second embodiment of the present invention. The quantum chip 200′ has all features of the quantum chip 200 according to the second embodiment and additional qubit-qubit couplers (thick dashed lines and solid lines) 250 coupled to pairs of qubits in the bulk and at the boundary of the quantum chip 200′. The additional qubit-qubit couplers may be arranged in the same plane as the unit cells, further qubits and tunable couplers. In the embodiment shown in FIG. 4f, two-qubit gates are applied in parallel between qubits linked by dashed lines which indicate couplings provided either by the coupling structures (coupling indicated by dashed line T) or by the additional qubit-qubit couplers (dashed lines 250). No two-qubit gates are currently applied between pairs of qubits linked by the solid line 250 (i.e., between qubit pairs 211a-214a, 212a-215a, 213a-216a, 238-240), though gates between qubits of these pairs may be applied at another time step (circuit layer). The quantum chip 200′ allows for a larger number of two-qubit gates that may be applied in parallel than the quantum chip 200. In particular, one may achieve maximum parallelism for the gates shown in the Figure. All coupling structures 221-229, tunable couplers and additional qubit-qubit couplers 250 are arranged free of crossings in the quantum chip 200′.

FIG. 5 is a schematic representation of a quantum chip 300 according a third embodiment of the present invention. The quantum chip 300 comprises a plurality of qubits (filled circles), a plurality of coupling structures 321, 322, 323 (thick, solid line), each comprising a resonator for example a CPW resonator, a waveguide or other signal-conducting transmission line, and a plurality of tunable couplers 360 (squares and thin lines) for providing the coupling between the qubits and the coupling structures. All qubits and coupling structures are arranged in one plane, preferably on a substrate. In one example of the third embodiment, the qubits are superconducting qubits. The quantum chip 300 according to the third embodiment is similar to the quantum chip 100 according to the first embodiment in that the qubits are arranged on the vertices of a two-dimensional hexagonal lattice. However, the quantum chips 100 according to the first embodiment and the quantum chip 300 according to the third embodiment differ in the structure of the unit cell.

The boundary region 303 of the quantum chip 300 is schematically represented with a black frame. The coupling between qubits and coupling structures at the boundary region 303 may be different from that in the bulk.

The quantum chip 300 shown in FIG. 5 comprises a plurality of unit cells arranged in a two-dimensional pattern 301, each comprising a coupling structure 321, 322, 323, and four qubits 311a,b,c,d, 312a,b,c,d, 313a,b,c,d coupled thereto. In FIG. 5, the qubits and coupling structures of only three unit cells are provided with reference signs to increase the legibility of the figure. More specifically, a first unit cell comprises four first qubits 311a,b,c,d coupled to a first coupling structure 321, a second unit cell comprises four second qubits 312a,b,c,d coupled to a second coupling structure 322, and a third unit cell comprises four third qubits 313a,b,c,d coupled to a third coupling structure 323. The first, second and third unit cells are adjacent to each other. Furthermore, out of the first, second and third qubits 311a,b,c,d, 312a,b,c,d, 313a,b,c,d, only the third qubit 313a is coupled to the first, second and third coupling structures 321, 322, 323 of the three adjacent first, second, and third unit cells.

In the quantum chip 300 shown in FIG. 5, there are bulk qubits, like qubits 311a, 311d, 312a, 312d, 313a, 313d coupled to three different coupling structures. However, there are also other bulk qubits, like qubits 311b, 311c, 312b, 312c, 313b, 313c coupled to only two coupling structures. For bulk qubits there is a maximum connectivity of 22.

The coupling structures and tunable couplers are arranged such that they are free of crossings which is beneficial for the quality of the quantum chip 300.

FIG. 6 is a schematic representation of a quantum chip 400 according a fourth embodiment of the present invention with a two-dimensional pattern 401 of unit cells. The quantum chip 400 according to the fourth embodiment comprises all elements of the quantum chip 100 according to the first embodiment and comprises additional long-range qubit-qubit couplers 450 (thick wriggled lines) coupling spatially distant pairs of qubits of the quantum chip 400. Additionally, or alternatively, the quantum chip 400 may comprise additional long-range qubit coupling structure couplers between a first qubit of a first unit cell and a second coupling structure of a second, in particular non-adjacent, unit cell, and/or additional long-range coupling structure—coupling structure couplers between a third coupling structure of a third unit cell and a fourth coupling structure of a fourth unit cell. In particular, the third and fourth unit cells are non-adjacent unit cells. Each additional qubit-qubit coupler 450 crosses coupling structures 121, 122, 123 and tunable couplers 160 as it extends along a path between the qubits of the pair. Each additional qubit-qubit coupler 450 may be arranged on the same plane as the unit cells in one example. Then, crossings between the qubit-qubit coupler, the coupling structures and the tunable couplers may be implemented via airbridges. Alternatively, the additional qubit-qubit couplers 450 may be arranged on a different layer than the unit cells, e.g., on another side of a flip-chip architecture compared to the unit cells. The quantum chip 400 may have a connectivity which is beneficial for certain quantum computing applications, like the implementation of QEC codes, in particular qLDPC codes.

FIG. 7 is a schematic representation of a quantum chip 500 according to a fifth embodiment of the present invention. The quantum chip 500 comprises two copies 101a,b of the pattern of the quantum chip 100 according to the first embodiment, i.e., a pattern 100a and another pattern 100a, each comprising a plurality of unit cells. As for the quantum chip 100 according to the first embodiment, each unit cell comprises one coupling structure and two qubits coupled thereto. The two patterns 101a,b are coupled to each other via a connecting structure 550.

The two patterns 101a, b are spaced apart from each other. In particular, their boundaries do not share a common region or a common point and there is a gap of a certain size between the boundaries of the two patterns 101a, b, and the connecting structure 550 is arranged in the gap. In particular, the two patterns 101a,b do not share a common qubit.

In the embodiment of the quantum chip 500 shown in FIG. 7, the connecting structure 550 comprises a plurality of connector qubits 551 arranged in a square lattice configuration, wherein nearest-neighbor qubits are coupled to each other by qubit-qubit couplers 552 (solid black lines; only one qubit-qubit coupler is provided with a reference sign in the figure to improve legibility). However, the connecting structure 550 is not limited to this configuration, and other configurations are conceivable for the connecting structure 550. Qubits 551 arranged at the boundary of the connecting structure 550 are coupled to coupling structures of the patterns 100a,b or are coupled to qubits of the patterns 100a,b via qubit-qubit couplers. The connector qubits 551 may be the same type of qubit as the qubits 111a,b, 112a,b, 113a,b of the patterns in one example. I.e., in particular, the connector qubits 551 may be superconducting qubits in one example. Each of the two patterns 101a,b may comprise for at least one, and preferably for each qubit of the unit cells a readout resonator, while the connecting structure 550 does not comprise readout resonators for the connector qubits 551.

The arrangement of the connector qubits 51 is not limited to a square lattice configuration.

The connecting structure 550 provides a connection between the two patterns 101a,b that may enable an implementation of logical quantum gates on logical qubits defined by (data) qubits of only one of the patterns 101a or 101b or both patterns 101a and 101b.

FIG. 8 is a schematic representation of a quantum chip 700 according to a sixth embodiment of the present invention. The quantum chip 700 comprises a two-dimensional pattern 701 of unit cells which is similar to the two-dimensional pattern 101 of unit cells of the quantum chip 100 according to the first embodiment. In particular, each unit cell comprises one coupling structure and two qubits coupled thereto. The quantum chip 700 further comprises at least one region 702a,b being adjacent to the two-dimensional pattern 101 of unit cell of the quantum chip 100. The at least one region 702a,b comprises a plurality of qubits having connectivity between themselves. The qubits of the at least one region 702a,b may be the same type of qubits as the qubits of the two-dimensional pattern 701a, or may be different. The qubits of the at least one region 702a,b have connectivity between themselves, for example by use of qubit-qubit couplers and/or coupling structures, but the invention is not limited to this. The connectivity of the qubits of the at least one region is different to the connectivity of the qubits of the two-dimensional pattern 701. The at least one region 702a,b is configured as a magic state factory, i.e., it is configured to generate magic states. For more details on magic state and magic state factory, please see Joe O′Gorman and Earl T. Campbell, “Quantum computation with realistic magic-state factories,” Phys. Rev. A 95, 032338 (2017). For this, there is connectivity between some of the qubits of the at least one region 702a,b and some of the qubits of the two-dimensional pattern 701 to allow for magic state injection, so that the magic state produced in the at least one region 702a,b can be used in the two-dimensional pattern 701.

In one example of the sixth embodiment, there may be a single region 702a or 702b comprising the plurality of qubits and being configured as a magic state factory. The at least one region may be arranged at an edge of the two-dimensional pattern 701, as shown in FIG. 8, or it may surround the two-dimensional pattern, in particular surround the two-dimensional pattern 701 completely. Then, there may be connectivity between qubits at the boundary of the surrounding region and qubits at the boundary of the two-dimensional pattern 701. As an example of this sixth embodiment, as shown in FIG. 8, two regions, namely a first and a second region 702a,b may be arranged in the same plane as the two-dimensional pattern 701 adjacent to opposite edges the two-dimensional pattern 701 of unit cells. Each of the first and second regions 702a,b comprises a plurality of qubits. The qubits of the first and second regions 702a,b may be the same type of qubits as the qubits of the two-dimensional pattern 701. The qubits of each of the first and second regions 702a,b have connectivity between themselves, for example by use of qubit-qubit couplers and/or coupling structures, but the invention is not limited to this. However, there may be no connectivity between a qubit in the first region and a qubit in the second region. The connectivity between the qubits of the first and second regions may be different than the connectivity of the qubits of the two-dimensional pattern 701. The first and second regions 702a,b are configured as a magic state factory, i.e., they are configured to generate magic states. There is connectivity between some of the qubits of the first and second regions 702a,b and some of the qubits of the two-dimensional pattern 701 to allow for magic state injection. The quantum chip 700 according to the sixth embodiment is particularly suitable for performing quantum error correction. Many interesting quantum error correcting codes only allow to implement Clifford gates between logical qubits. However, when magic states are available, a universal set of quantum gates may be implemented on the logical qubits by use of the magic states. Therefore, in the quantum chip according to the sixth embodiment, a quantum error correcting code may be implemented on the qubits of the two-dimensional pattern 701, and the first and second regions 702a,b may be operated as a magic state factory.

The quantum chip 700 shown in FIG. 8 comprises two regions 702a,b configured as magic state factories. This allows for a fast injection of the magic states for non-Clifford operations, thereby decreasing the runtime of a fault-tolerant algorithm.

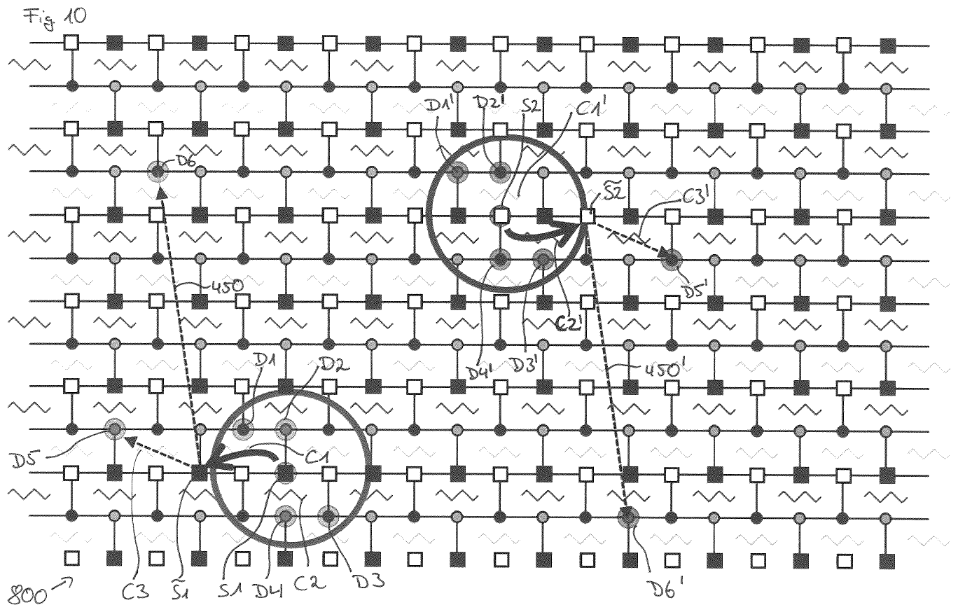

FIG. 9 is a schematic representation of a quantum chip 600 according to a seventh embodiment of the present invention. The quantum chip 600 comprises three copies 401a,b,c of the pattern 401 of the quantum chip 400 according to the fourth embodiment, i.e., a pattern 401a and two other patterns 401b,c, each of the three patterns 400a,b,c comprising a plurality of unit cells. As for the quantum chip 400, each unit cell comprises one coupling structure and two qubits coupled thereto. Furthermore, there is a plurality of additional qubit-qubit couplers 450 coupled to pairs of qubits of the pattern (only one qubit-qubit coupler is provided with a reference sign in the figure to improve legibility). The quantum chip 600 according to the seventh embodiment may comprise for each of the three patterns respective first and second regions 702a,b, similar to the first and second regions 702a,b of the quantum chip 700 according to the sixth embodiment shown in FIG. 8. I.e., each of the first and second regions 702a,b may comprise a plurality of qubits having connectivity between themselves, the first and second regions 702a,b being configured as a magic state factory. There may be connectivity between some qubits of the first and second regions 702a,b and some of the qubits of the respective two-dimensional patterns 401a,b,c to allow for magic state injection. The qubits of the first and second regions 702a,b may be the same type of qubits as the qubits of the two-dimensional pattern.

The patterns 401a,b,c are stacked on top of each other, and pairs of neighboring patterns 401a,b,c are coupled to each other via a connecting structure 650. However, the neighboring patterns need not necessarily be stacked on top of each other, and one may conceive other examples of a quantum chip according to the present invention that comprises a plurality of coupled patterns. For example, the three patterns 401a,b,c may be arranged in the same plane, and the connecting structures may also be arranged in the same plane. The connecting structure 650 may be similar to the connecting structure 550 shown in FIG. 7, and its description is therefore omitted.

The quantum chips 100, 200, 200′, 300, 400, 500, 600, 700 according to the first to seventh embodiment and the modification have a connectivity that may be beneficial for efficiently performing quantum computation according to the method of the second aspect of the present invention.

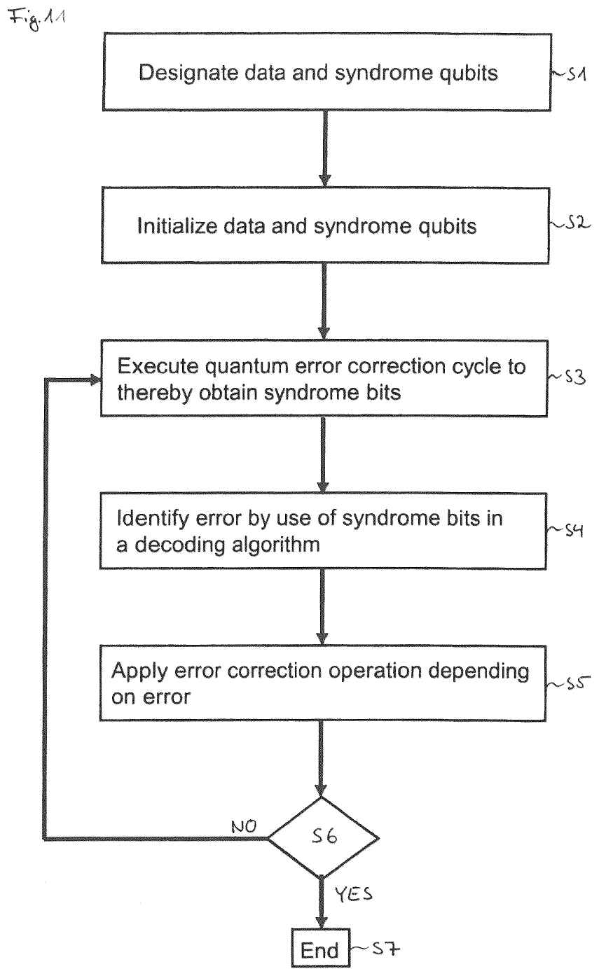

FIG. 10 is a schematic representation of the quantum chip 800 according to the first aspect of the present invention on which a measurement of stabilizer operators of a quantum Low Density Parity Check code with weight 6 is carried out. The quantum chip 800 comprises a plurality of qubits that are used either as data qubits (circles) or as syndrome qubits (squares), and a plurality of coupling structures (wiggly lines). Each coupling structure is surrounded by six qubits and is coupled to the surrounding qubits, e.g., via tunable couplers, to thereby enable the implementation of two-qubit gates between the qubits coupled thereto. As it is clear from FIG. 10, the quantum chip 800 comprises a plurality of unit cells arranged in a two-dimensional pattern, each comprising one coupling structure and two qubits coupled thereto. Such a pattern is equivalent to the one shown in FIG. 1. As has been explained above, for each set of three adjacent unit cells, there is only one single qubit of the qubits of the three adjacent unit cells coupled to each coupling structure of the three adjacent unit cells.

The quantum chip 800 further comprises a plurality of long-range (non-local) couplers as explained above. To improve the legibility of FIG. 10, only two long-range couplers 450, 450′ are shown, namely between a syndrome qubit [symbol] and a data qubit D6, and between a syndrome qubit [symbol] and a data qubit D6′. However, these long-range couplers are arranged between other pairs of data and syndrome qubits to thereby form a translationally invariant pattern in the bulk, as will become clear from the explanation below.

The quantum chip 800 is particularly well suited for implementing a qLDPC code that requires a measurement of first and second stabilizer operators of weight 6 that have support on the data qubits D1, D2, D3, D4, D5, D6 and D1′, D2′, D3′, D4′, D5′, D6′ as indicated in the figures. Further stabilizer operators of the QLDPC code are obtained from the first and second stabilizer operators by translation in the two directions of the two-dimensional pattern as it is clear to those skilled in the art.

The first stabilizer operator may be measured by use of the syndrome qubit S1. The required two-qubit gates for the measurement of the stabilizer operator between the syndrome qubit S1 and the data qubits D1, D2, D3, D4 may be directly implemented by use of the coupling structures C1 and C2. The two-qubit gate between the syndrome qubit S1 and the data qubits D5 and D6 may be implemented by moving the state of the syndrome qubit S1 to the syndrome qubit [symbol] by implementing MOVE operations that involves the coupling structure C1, by applying a two-qubit gate between the syndrome qubit [symbol] and the data qubit D5 by use of the coupling structure C3 and by applying the two-qubit gate between the syndrome qubit [symbol] and the data qubit D6 by use of the long-range coupler 450.

Similarly, the second stabilizer operator may be measured by use of the syndrome qubit S2. The required two-qubit gates for the measurement of the stabilizer operator between the syndrome qubit S2 and the data qubits D1′, D2′, D3′, D4′ may be directly implemented by use of the coupling structures C1′ and C2′. The two-qubit gate between the syndrome qubit S2 and the data qubits D5′ and D6′ may be implemented by moving the state of the syndrome qubit S2 to the syndrome qubit [symbol] by implementing MOVE operations that involves the coupling structure C2′, by applying a two-qubit gate between the syndrome qubit [symbol] and the data qubit D5′ by use of the coupling structure C3′ and by applying the two-qubit gate between the syndrome qubit [symbol] and the data qubit D6′ by use of the long-range coupler 450′.

The measurement of each of the two stabilizer operators requires only two MOVE operations and is thereby highly efficient.

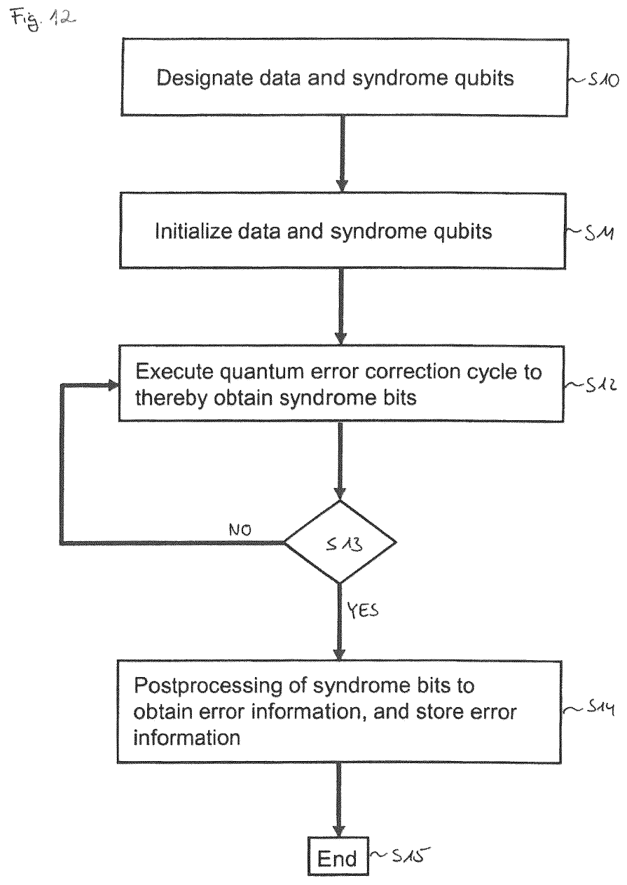

FIG. 11 is a flowchart of a first embodiment of a method of implementing quantum error correction on a quantum chip according to the second aspect of the present invention, wherein the quantum chip is according to the first aspect of the present invention. In one example, the quantum chip has a connectivity that is particularly suitable for the implementation of the quantum error correction code, see e.g., FIG. 10 above and its description.

The method starts at S1 with designating, among the qubits of the quantum chip, a plurality of data and syndrome qubits for the implementation of the quantum error correction code on the quantum chip with a shortest quantum error correction cycle according to the parity check matrix of the code.

Then, at step S2, each of the plurality of data and syndrome qubits is initialized in a predetermined initial state. E.g., a predetermined logical state is determined and encoded in the data qubits according to the quantum error correction code. In one example, each syndrome qubit may be prepared in the |0>state.

At step S3, a quantum error correction cycle may be executed on the quantum chip. The execution comprises an error detection step which comprises implementation of a sequence of quantum gates on the data and syndrome qubits followed by a measurement of the state of the syndrome qubit according to the QEC code, in particular in the computational basis, to thereby obtain a plurality of syndrome bits associated with said cycle. The syndrome bits may be indicative of an error.

At step S4, the syndrome bits are used in a decoding algorithm executed by a classical computer to identify the error.

Then, at step S5, a quantum error correction operation is applied to the data qubits, wherein application of said quantum error correction operation comprises an application of a sequence of quantum gates to the data qubits which are affected by an error, the sequence depending on identified error.

Then, at step S6, it is determined whether a predetermined number of quantum error correction cycles is reached. If the answer is NO, the method returns to step S3. If the answer is YES, the method terminates at step S7. In this way, active quantum error correction may be achieved. Similar techniques may be used to perform logical gates.

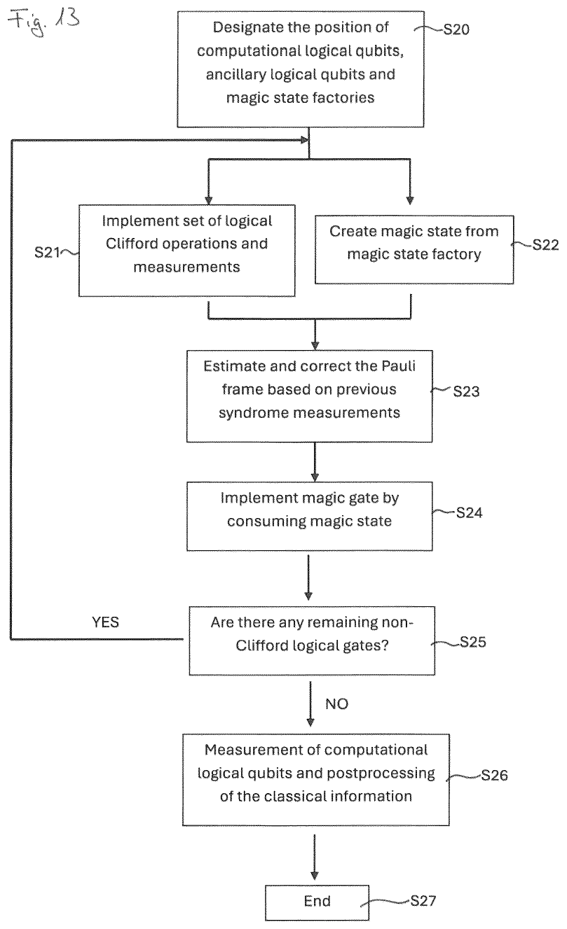

FIG. 12 is a flowchart of a second embodiment of a method of implementing quantum error correction on a quantum chip according to the second aspect of the present invention, wherein the quantum chip is according to the first aspect of the present invention.

The method starts at S10 with designating, among the qubits of the quantum chip, a plurality of data and syndrome qubits for the implementation of the quantum error correction code on the quantum chip with an optimum code minimum distance and a shortest quantum error correction cycle according to the parity check matrix of the code.

Then, at step S11, each of the plurality of data and syndrome qubits is initialized in a predetermined initial state. E.g., a predetermined logical state is determined and encoded in the data qubits according to the quantum error correction code. In one example, each syndrome qubit may be prepared in the |0>state.

At step S12, a quantum error correction cycle may be executed on the quantum chip. The execution comprises an implementation of a sequence of quantum gates on the data and syndrome qubits followed by a measurement of the state of the syndrome qubit, in particular in the computational basis, according to the QEC code, to thereby obtain a plurality of syndrome bits associated with said cycle and indicative of an error. The syndrome bits are stored on a memory.

Then, at step S13, it is determined whether a predetermined number of quantum error correction cycles is reached. If the answer is NO, the method returns to step S12. If the answer is YES, the method proceeds with step S14. At step S14, the syndrome bits are postprocessed to obtain error information indicative of an error, and the error information is stored, e.g., on a memory. Postprocessing may be implemented by a classical computer. In this way, passive quantum error correction may be achieved.

FIG. 13 a flowchart of an embodiment of a method of implementing a fault-tolerant quantum computation on a quantum chip according to the second aspect of the present invention, wherein the quantum chip is according to the first aspect of the present invention and comprises a region configured as a magic state factory. For example, the quantum chip may be the quantum chip 700 shown in FIG. 8. The quantum computation requires the implementation of a sequence of Clifford and non-Clifford operations/gates.

The method starts at step S20 with designating positions of computational logical qubits and ancillary logical qubits, and designating the position of the magic state factory or factories on the quantum chip. Ancillary logical qubits may be used to implement logical operations, Clifford and non-Clifford, inside or between patches. One example is the implementation of a logical CNOT between two patches of surface codes, where one needs ancillary logical qubits to implement the operation. In particular, the designation is such that there is connectivity between qubits of the magic state factory/factories and qubits of the computational and/or ancillary logical qubits.

The method proceeds with steps S21 and S22. These steps may be carried out in parallel in one example. In step S21, a set of logical Clifford operations and syndrome measurements is implemented on the computational and ancillary logical qubits. At step S22, a magic state is created by the magic state factory or factories.

The method proceeds with step S23, where the Pauli frame (see e.g. E. Knill, “Quantum computing with very noisy devices”, quant-ph/0410199v2, 2004) is estimated and corrected based on previous syndrome measurements.

At step S24, a magic gate is implemented by consuming the magic state. The implementation of the magic gate is also called gate teleportation. It uses magic states and logical Clifford gates, where the magic state is consumed in the process of implementing the magic gate. These logical Clifford gates are between the magic state qubits and the logical qubits

At step S25 it is verified whether there are remaining non-Clifford gates. If the answer is YES, the method returns to steps 21 and 22. If the answer is NO, the computational logical qubits are measured and the obtained classical information is postprocessed to thereby implement fault-tolerant quantum computation, and the method terminates at S27.

1. A quantum chip comprising a plurality of unit cells arranged in a two-dimensional pattern, each unit cell comprising at least one coupling structure and at least two qubits coupled thereto, characterized in that there are at least three adjacent unit cells with only a single qubit of the qubits of the at least three adjacent unit cells coupled to the at least one coupling structure of each of the three adjacent unit cells.

2. The quantum chip according to claim 1, wherein for each set of at least three adjacent unit cells of the pattern there is only a single qubit of the qubits of the at least three adjacent unit cells coupled to the at least one coupling structure of each of the three adjacent unit cells.

3. The quantum chip according to claim 1, wherein the qubits are superconducting qubits and for at least one unit cell the at least one coupling structure comprises a resonator.

4. The quantum chip according to claim 1, wherein for at least one unit cell the at least one coupling structure comprises a tunable coupler.

5. The quantum chip according to claim 1, wherein the quantum chip comprises for at least one qubit a coupler, preferably a tunable coupler, providing the coupling between the qubit and one of the at least one coupling structures.

6. The quantum chip according to claim 1, wherein the quantum chip comprises at least one further qubit coupled to the at least one coupling structure of one or more unit cells.

7. The quantum chip according to claim 6, wherein the qubits of the unit cells and the at least one further qubit are arranged in a lattice structure, preferably in a hexagonal lattice structure or in a brick wall lattice structure, wherein for each unit cell the at least one coupling structure is arranged at one of the plaquettes of said lattice structure, and for each plaquette the qubits surrounding said plaquette are coupled to the at least one coupling structure arranged at said plaquette.

8. The quantum chip according to claim 7, said quantum chip comprising for at least one pair of qubits an additional qubit-qubit coupler, preferably a tunable coupler, the qubits of the pair of qubits being coupled thereto.

9. The quantum chip according to claim 8, wherein the unit cells, the couplers, and/or the qubit-qubit couplers are arranged in one plane.

10. The quantum chip according to claim 9, wherein the at least one coupling structure of each unit cell and/or the couplers and/or the qubit-qubit couplers are arranged free of crossings.

11. The quantum chip according to claim 10, wherein at least one qubit-qubit coupler comprises a long-range coupler extending along a path between the qubits of the pair of qubits while crossing the at least one coupling structure of at least one unit cell, at least one of the couplers and/or at least one other qubit-qubit coupler.

12. The quantum chip according to claim 11, wherein said quantum chip comprises another plurality of other unit cells arranged in another two-dimensional pattern, each other unit cell comprising at least one other coupling structure and at least two qubits coupled thereto, wherein there are at least three adjacent other unit cells with only a single qubit of the qubits of the at least three adjacent other unit cells coupled to the at least one other coupling structure of each of the at least three adjacent other unit cells, the two-dimensional patterns being spaced apart from each other, and the quantum chip further comprises a connecting structure which is arranged between the two patterns and is coupled to at least one qubit and/or the at least one coupling structure, respectively other coupling structure, of each of the patterns.

13. The quantum chip according to claim 12, wherein said connecting structure comprises a plurality of connector qubits arranged in a two-dimensional connector lattice structure with nearest-neighbor coupling, and connector qubits at a boundary of the connector lattice structure are coupled to at least one qubit and/or the at least one coupling structure, respectively the at least one other coupling structure of unit cells, respectively other unit cells, of each of the patterns at respective boundaries thereof.

14. The quantum chip according to claim 1, said quantum chip further comprising at least one region, said at least one region comprising a plurality of qubits having connectivity between themselves, wherein there is connectivity between qubits of the at least one region and qubits of the two-dimensional pattern, wherein the connectivity between qubits of the at least one region is different than the connectivity between qubits of the two-dimensional pattern, in particular the at least one region is configured as a magic state factory.

15. A method of performing quantum computation, in particular quantum simulation of a fermionic system or implementing quantum error correcting code, more in particular a quantum Low-Density Parity Check code, on a quantum chip according to claim 1.

16. The method according to claim 15, said method comprising an implementation of a plurality of two-qubit gates between a plurality of pairs of qubits, wherein for each pair the qubits of said pair are coupled to the same coupling structure or are coupled by the additional qubit-qubit coupler.

17. The method according to claim 16, wherein the quantum computation comprises the implementation of a quantum error correcting code, in particular a sparse quantum error correcting code, even more particular a quantum Low-Density Parity-Check code, said quantum error correcting code being defined by a parity check matrix, said method comprising:
designating, among the qubits of the quantum chip, a plurality of data and syndrome qubits for the implementation of the quantum error correcting code with a short quantum error correction cycle according to the Parity Check matrix;
initializing each of the plurality of data and syndrome qubits in a predetermined initial state;
executing the quantum error correction cycle on the quantum chip, wherein the execution comprises an error detection and/or correction step which comprises implementation of quantum gates on the data and syndrome qubits followed by a measurement of the state of the syndrome qubits to thereby obtain a plurality of syndrome bits associated with said cycle, the syndrome bits being indicative of an error, wherein the implementation of the quantum gate comprises implementation of at least one two-qubit gate on a pair of qubits coupled to the same coupling structure.

18. The method according to claim 17, wherein the method comprises a parallel application of a plurality of quantum gates on a plurality of pairs of qubits, wherein for each pair of qubits the qubits of the pair of qubits are coupled to the same coupling structure.

19. The method according to claim 18, said method comprising an implementation of a logical qubit gate, wherein said implementation comprises an implementation of a single-qubit gate and/or a two-qubit gate on at least one of the data qubits using the connecting structure connecting the two patterns of the two-dimensional pattern and the other two-dimensional pattern of the quantum chip.

20. The method according to claim 19, wherein the method is a method of implementing a quantum error correcting code and wherein one or more logical qubits and/or memories are created from the plurality of qubits by encoding according to the quantum error correcting code, wherein in particular some of the qubits of a respective logical qubit or memory are part of a respective plurality of qubits coupled to the same coupling structure.
